(19) United States
(12) Patent Application Publication
(10) Pub. No.: US 2007/0072070 A1
(43) Pub. Date: Mar. 29, 2007

(54) Substrates for deposited electrochemical cell structures and methods of making the same

(75) Inventors: Shu Ching Quek, Clifton Park, NY (US); Anteneh Kebbede, Niskayuna, NY (US); Harish Radhakrishna Acharya, Clifton Park, NY (US); Sauri Gudlavalleti, Albany, NY (US); Andrew Philip Shapiro, Schenectady, NY (US); Venkat Subramaniam Venkataramani, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/235,552

(22) Filed: Sep. 26, 2005

(51) Int. Cl. H01M 6/42; H01M 8/12; H01M 4/94; C25B 9/00

(52) U.S. Cl. 429/149; 429/32; 429/44; 204/267

(57) ABSTRACT

An electrochemical cell structure comprises a conductive base defining a plurality of holes passing through the conductive base and a microporous cellular substrate disposed on the conductive base. In another embodiment, an electrochemical cell structure comprises a conductive base defining a plurality of holes passing through the conductive base, a coarse microporous cellular substrate disposed on the conductive base and a fine microporous cellular substrate disposed on the coarse microporous cellular substrate.

### CROSS REFERENCE TO RELATED APPLICATIONS

This application is related to co-pending US Patent Application, Docket Number 145463-1, Ser. No. ______, entitled “Electrochemical Cell Structures And Methods Of Making The Same,” and co-pending US Patent Application, Docket Number 163855-1, Ser. No. ______, entitled “Solid Oxide Fuel Cell Structures, and Related Compositions and Processes,” each filed contemporaneously herewith, which applications are hereby incorporated by reference.

### BACKGROUND

This invention relates generally to electrochemical cell structures and more specifically to substrates for depositing electrochemical cell components and methods of making the same.

Electrochemical cells are energy conversion devices that are usually classified as either electrolysis cells or fuel cells. Electrolysis cells can function as hydrogen generators by electrolytically decomposing water to produce hydrogen and oxygen gases. Fuel cells electrochemically react a hydrogen gas with an oxidant across an exchange membrane or electrolyte to generate electricity and produce water. Fuel cells, such as solid oxide fuel cells, have demonstrated a potential for high efficiency and low pollution and have many potential applications including large-scale power generation, distributed power and use within automobiles.

One of the key challenges related to electrochemical cell advancement is to develop cost effective processes to manufacture electrode and electrolyte materials, especially with large surface areas.

Accordingly there is a need in the art for improved electrochemical cell design and associated fabrication techniques.

### BRIEF DESCRIPTION

An electrochemical cell support structure comprises a conductive base defining a plurality of holes or openings passing through the conductive base and a microporous cellular substrate disposed on the conductive base. In another embodiment, an electrochemical cell support structure comprises a conductive base defining a plurality of holes passing through the conductive base, a coarse microporous cellular substrate disposed on the conductive base and a fine microporous cellular substrate disposed on the coarse microporous cellular substrate.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of one embodiment of the instant invention.

FIG. 2 is a flow chart depicting method steps associated with one embodiment of the instant invention.

FIG. 3 is a micrograph of a deposited cell structure in accordance with one embodiment of the instant invention.

FIG. 4 is another micrograph of a deposited cell structure in accordance with one embodiment of the instant invention.

FIG. 5 is another schematic illustration of one embodiment of the instant invention.

FIG. 6 is a graphical illustration of buckling load factor and tape thickness.

FIG. 7 is a graphical illustration of buckling load factor and porosity.

FIG. 8 is a graphical illustration of buckling load factor and heat flux.

FIG. 9 is another schematic illustration of one embodiment of the instant invention.

FIG. 10 is another schematic illustration of one embodiment of the instant invention.

FIG. 11 is a flow chart depicting method steps associated with one embodiment of the instant invention.

FIG. 12 is another schematic illustration of one embodiment of the instant invention.

FIG. 13 is another schematic illustration of one embodiment of the instant invention.

### DETAILED DESCRIPTION

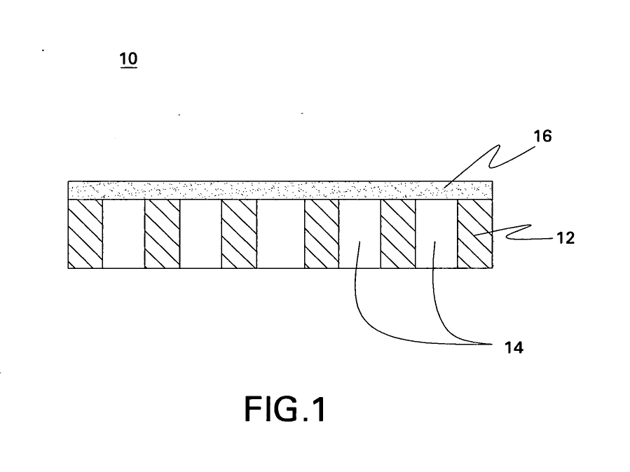

An electrochemical cell support structure 10 comprising a conductive base 12 defining a plurality of holes 14 passing through the conductive base 12 and a microporous cellular substrate 16 disposed on the conductive base 12, is shown in FIG. 1. As discussed above, one of the key challenges for the advancement of electrochemical cells is the development of cost effective processes to manufacture cell components including electrode and electrolyte materials, especially suitable for larger surface area cells. Electrochemical cell support structure 10 addresses this issue and is particularly suitable for use in the manufacture of solid oxide fuel cells (SOFC), especially using deposition techniques.

Conventionally electrochemical cell structures, especially SOFC structures, are processed using sintering methods. There are, however, significant limitations of these sintering methods, especially when used in large cell fabrication. Direct deposition techniques, as discussed below, overcome many of the limitations of these sintering methods, especially in regards to large cell fabrication.

Electrochemical cell support structure 10 is ideally suited for use with deposition processes, as microporous cellular substrate 16 provides a relatively smooth surface to support deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF) or other deposition techniques.

Conductive base 12 typically comprises a plate-type structure that includes a series of holes 14 that pass through, allowing fluid flow, for example fuel or oxidant flow, to flow from one side of conductive base 12 to an opposite side of conductive base 12. Alternatively, conductive base 12 includes a series of flow-optimized pillars that allow reactants to flow thereabout. Accordingly, conductive base 12 can comprise a perforated solid piece or a series of pillar supports that permit flow through the thickness or parallel to the base respectively. In one embodiment, the holes have a diameter between about 0.25 inches to about 1.0 inch. As discussed herein, the term “holes” refers to any type of void, slot, groove or other cavity arrangement that allows fluid flow to pass from one side of conductive base 12 to the opposite side. Conductive base 12 is typically made of metals that oxidize slowly under the operating conditions associated with solid oxide fuel cell (SOFC) and solid oxide electrolyzer cell (SOEC) applications, namely, high temperatures and pressures. Conductive base 12 is typically a metallic interconnect made of iron, chromium, nickel, tin, combinations thereof or other materials conventionally used as interconnect materials, especially in SOFC and SOEC applications. Such materials conventionally include for example, chromium-containing alloys, iron chromium (FeCr), nickel chromium (NiCr), or nickel iron chromium (NiFeCr) based alloys or ferritic stainless steels such as E-Brite or other stainless steels. The dimensions of conductive base 12 and the accompanying holes 14 can vary greatly depending on the application and size requirements.

In one embodiment, microporous substrate 16 comprises a porous nickel (Ni) layer disposed on conductive base 12. The nickel substrate 16 has a good bond to the conductive base 12, typically a metallic interconnect, which bond is attained in a variety of ways including by using the methods discussed below. Additionally, the nickel substrate 16 comprises a sufficient porosity to allow gas flow needed to ensure proper cell functionality and is robust enough to enable deposition of the cell layers, including the electrode and electrolyte layers. In one embodiment, the microporous substrate 16 comprises iron, chromium, nickel, tin, or combinations thereof or other materials conventionally used a interconnect materials.

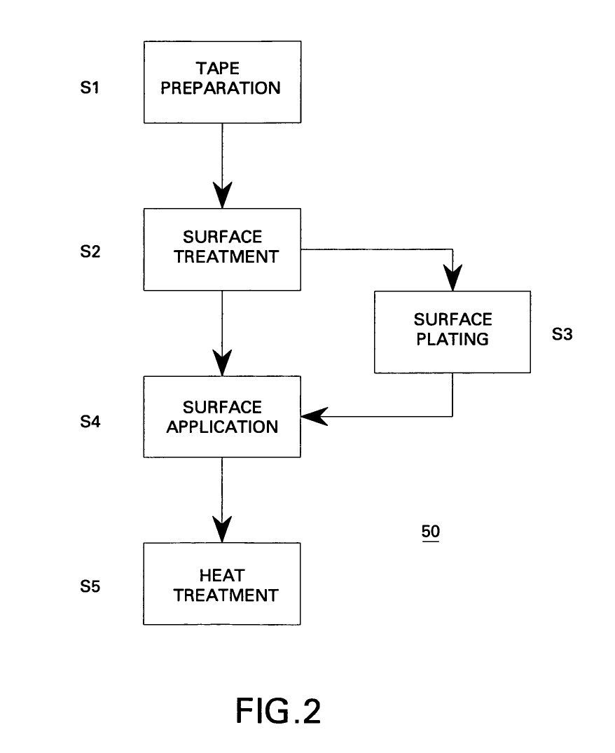

In one embodiment, nickel (Ni) layer 16 is created as depicted in the method steps of FIG. 2. According to method 50, electrochemical cell structure 10 is created by first, in S1, preparing a tape. In order to prepare the nickel oxide (NiO) tape, a slurry consisting of organic binders, plasticizers, NiO or Ni or a mixture of the two powders, and other additives is prepared and tape cast. Additives that can be used include zirconium (Zr) and yttrium (Y) to suppress grain growth in the Ni-layer and control the coefficient of thermal expansion or chromium (Cr) or iron (Fe) salts to enhance the adhesion between the Ni layer and the conductive base 12, typically a metal interconnect.

Next, in method step S2, an agent that acts as an initial adhesive or glue and subsequently serves as a bonding agent is applied to the surface of conductive base 12. The agent can comprise a variety of metal organic compounds including Ni acetyl acetonate, nickel octoate, nickel decanoate, and the like. The metal organics can be used to prepare solutions that can be applied to the metal surface using methods such as painting, dipping, or spinning or the like, that typically result in a thin layer being applied. The applied solution imparts tackiness to the surface so that subsequent layers, such as tape cast material, will adhere to the surface. Furthermore, the second and more critical role of the metal-organic layer is that it will leave behind a very thin layer of metal upon subsequent heat treatment, which layer facilitates the bonding between the base metal and the porous metal structure.

Optionally, method 50 may include a surface-plating step S3. In S3, the surface of the conductive base is coated with Ni-plating to enhance the bonding with the microporous cellular substrate 16. Additionally, Ni-plating also provides a protective layer against oxidation of the conductive base 12 during the subsequent heat treatments or during reduction of NiO.

Next, in method step S4, the NiO tape formed in S1 is applied to the surface of the conductive base 12. The NiO tape can be applied or laminated to the conductive base 12 using a variety of methods including, for example, manual rolling, warm pressing, and vacuum bagging. Vacuum bagging offers some advantage over other methods because it allows the lamination of the NiO tape to flat as well as irregular surfaces using a uniform pressure. Additionally, vacuum bagging ensures that gases evolving during the process are continuously removed and consequently reducing the probability of blister formation at the interface between the NiO tape and the conductive base 12.

Finally, in method step S5, the laminated substrate is put through a heat treatment cycle that uses an initial burnout phase followed by reduction and sintering phases. Typically the binder burnout phase is conducted in either air or wet hydrogen environments. The reduction and the sintering phases are typically conducted in a wet hydrogen environment. In this step, the NiO is reduced to Ni, the Ni is sintered and the bond between the Ni layer and the conductive base 12 forms, resulting in an electrochemical cell structure 10 having a substantially uniform microporous substrate 16 that is ideally suited as a substrate for deposition techniques in the manufacture of electrochemical cells, especially SOFC or SOEC cells.

### EXAMPLES

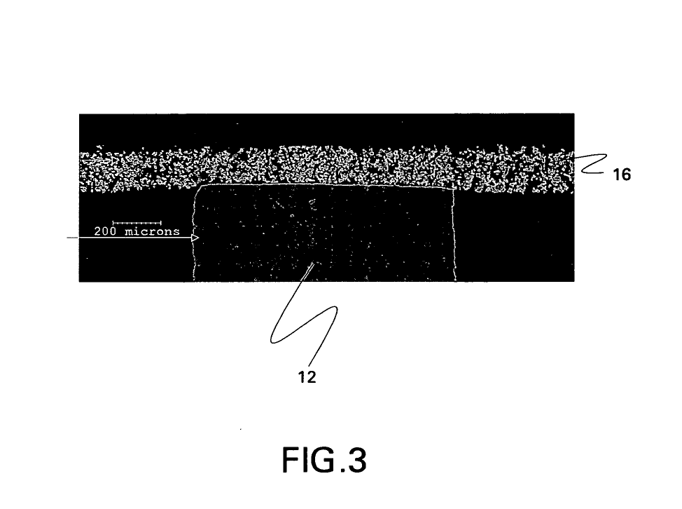

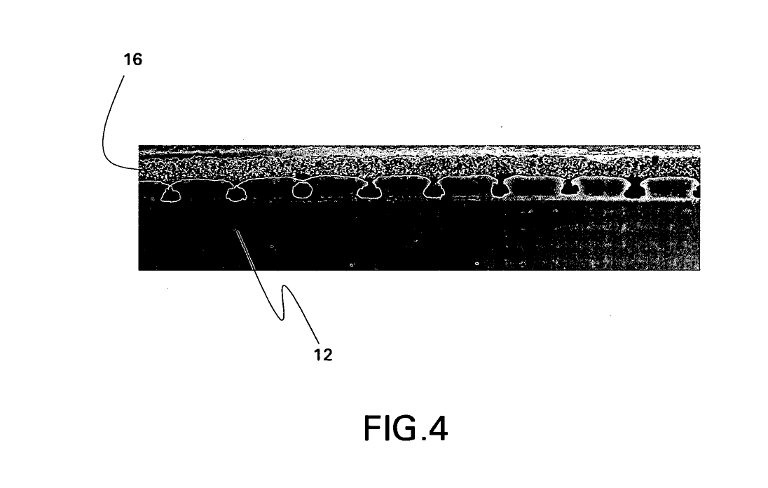

A few examples of electrochemical cell support structure 10 formation using method 50 are shown in FIGS. 3 and 4. FIG. 3 shows an example of an electrochemical cell support structure 10 formed using method 50. The top layer is a porous Ni layer 16 that was bonded to an E-Brite base plate 12 with approximately ⅛ inch hole diameters. The porous Ni layer 16 had a porosity of about 71% and resulted from the burn out and reduction of a green NiO tape that was originally attached to the E-Brite base plate 12. FIG. 4 shows another example of the electrochemical cell support structure 10 that also has additional layers deposited upon it. This embodiment includes both electrodes and an electrolyte that were deposited by plasma spray onto the electrochemical cell support structure 10.

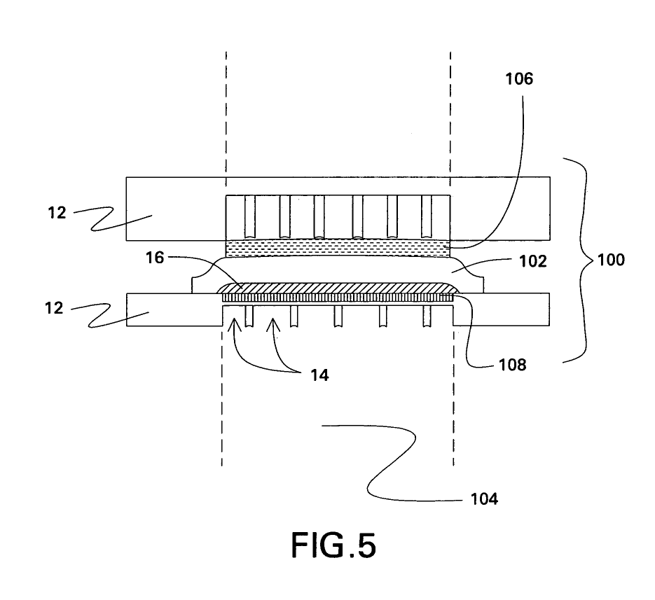

In another embodiment of the instant invention, the microporous cellular substrate 16 comprises a porous medium made of nickel (if used with a reducing gas) or any corrosion resistant metal or electronically conductive ceramic. For example, when used to enclose a reducing gas, nickel or any corrosion resistant metal or electronically conductive ceramic can be used as the microporous cellular substrate 16, followed by an anode, an electrolyte and a cathode. These layers can be applied using deposition techniques or by using any other thin film coating process. If the cathode is the first layer of film coating, typically only corrosion resistant metal or electronically conductive metals can be used as the microporous cellular substrate 16 as this layer will be subjected to an oxidizing environment. Microporous cellular substrate 16 can either be manufactured integrally with the conductive base 12 or it can be pre-fabricated and adhered to the conductive base 12 using a variety of techniques including, for example, brazing to avoid coarsening of the microstructure, chemical bonding or solid-state diffusion bonding. Once electrochemical cell structure 10 is formed, additional layers of cell can be deposited on the microporous cellular substrate 16 to create a cell 100, as shown in FIG. 5.

In FIG. 5, the conductive base 12 is covered by the microporous cellular substrate 16, which microporous cellular substrate 16 in one embodiment also serves as an electrode, for example an anode, within the cell 100. An electrolyte layer 102 completely covers the microporous cellular substrate 16 over the entire flow field 104 acting as a direct deposited seal to keep the oxidant and the fuel from mixing. An electrode 106, in this embodiment a cathode, is disposed on the electrolyte layer 102 surface opposite the microporous cellular substrate 16 and a second conductive base 12 is disposed adjacent the electrode 106 to form cell 100.

In an alternative embodiment, cell 100 may further comprise a perforated screen 108 interposed between the conductive base 12 and the microporous substrate 16, which screen 108 is typically comprised of the same material as that of the conductive base 12. Screen 108 is attached to conductive base 12 atop openings 14, or flow channels, using metallic joining methods, for example brazing. Screen 108 serves as a substrate for the deposition of the microporous substrate 16 across the openings 14 in conductive base 12 as a gas diffusion layer or as an electrode. Screen 108 is optionally used in this embodiment for increased structural durability.

In another embodiment, microporous cellular substrate 16 is grown on conductive base 12 using chemical or environmental heat treatments or a combination thereof. In yet another embodiment, microporous cellular substrate 16 is pre-manufactured and attached to the conductive base 12. Microporous cellular substrate 16 can be manufactured using a variety of methods. In one embodiment, microporous cellular substrate 16 is made by sintering a metallic powder using either gravity fed sintering or compacted sintering. This sintering is typically conducted in a vacuum atmosphere at temperatures high enough. for metal sintering. In another embodiment, microporous cellular substrate 16 is made by filling in macroporous foam with a metallic paste followed by thermal and/or environmental treatment so as to generate an appropriate microporous structure. For example, macroporous nickel foam has pore sizes that are typically too large for fuel cell deposition processes. In this embodiment, nickel foam is coated with a NiO paste that is prepared by mixing NiO powder with an organic binder such as polyvinyl butryl and solvents. Alternatively, a NiO slurry can be cast on top of the macroporous foam. The foam is then heat treated to burn out the organics contained within the paste, followed by a treatment in a reducing environment at temperatures that are high enough to create a partially sintered porous Ni filler structure within the macroporous foam. In yet another embodiment, microporous cellular substrate 16 is made using spray deposition or tape casting of metallic or metal-precursor particles such as metal oxides.

The thickness, pore volume, and pore size distribution within microporous cellular substrate 16 is typically determined by the deposition particle size and the allowed interfacial and/or interlaminar stress developed during the construct of the cell 100, given the strength of the electrolyte layer 102. Typically, the preferred pore size within the microporous cellular substrate 16 is between about 5 to about 30 microns, and more preferably between about 10 to about 20 microns. Additionally, the preferred porosity is typically within about 40 to about 85 percent, more preferably between about 50 to about 75 percent.

### Example

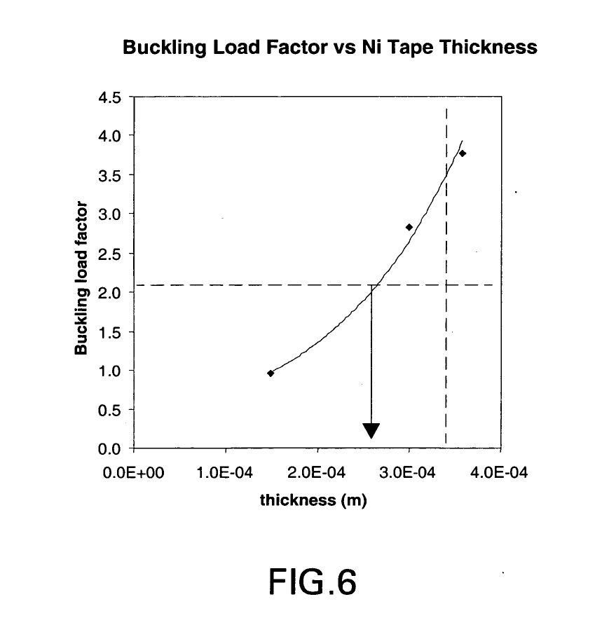

Given a set of material constants, FIGS. 6-8 specify required parameters of thickness, porosity and heat flux of the deposition process with a safety factor. In this particular configuration, the component needs to be of a specific thickness, typically, larger than 12 mils at 50% porosity for handability during the assembly process. If a very thick layer is used, resistance increases, affects the kinetics of elctrochemical reaction, and the inability to incorporate the gas diffusion layer (GDL) as an integral part of the interconnect because of large pressure drops due to the fine pore sizes.

In order to provide foam properties for specific material sets, transfer functions between buckling loads and substrate properties have been developed mathematically through the use of composite laminate theory applied to the conditions that cell 100 may encounter. Three of the most significant parameters related to the buckling failures of the substrate are: thickness; porosity; and heat flux of the deposited structure. The laminate theory is used for each material for certain heating conditions to obtain transfer functions that aid in determining substrate mechanical properties for the given conditions. FIG. 6-FIG. 9 show examples of how each parameter affects the buckling failure load for a given substrate. FIG. 6 charts the use of Ni substrates with a corrosive resistant stainless steel, commercially known as E-Brite, with a thermal expansion difference of about 3E⁻⁶/C and demonstrates how thickness of the substrate relates to buckling failure. The buckling load factor is the non-dimensionalized buckling stress generated from thermal loads. In FIG. 6, the y-axis gives the safety load factor and x-axis gives the thickness of the substrate. For example if a safety factor of two is required for the design, ˜0.00026 m would be chosen as the substrate thickness (as indicated on FIG. 6).

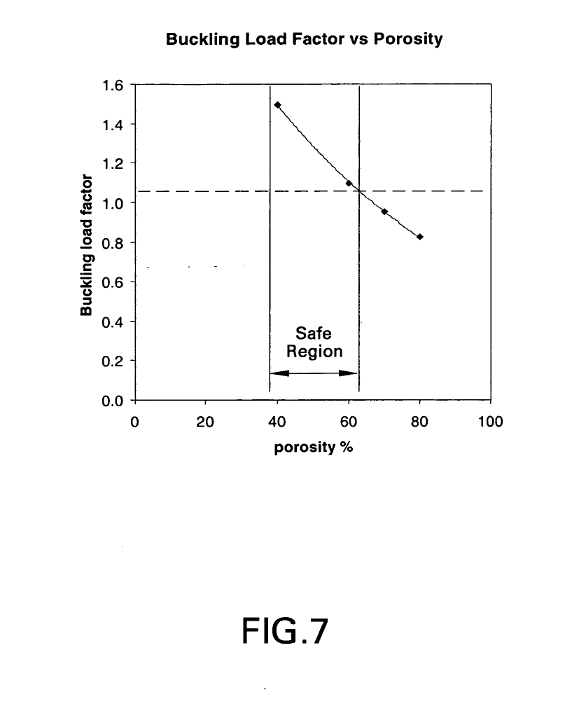

FIG. 7 shows the relationship of porosity to the buckling failure and the limits where the porosity is acceptable for this material system and temperature. The upper limit is set by mechanical failure conditions and the lower limit is set by the gas diffusion limit.

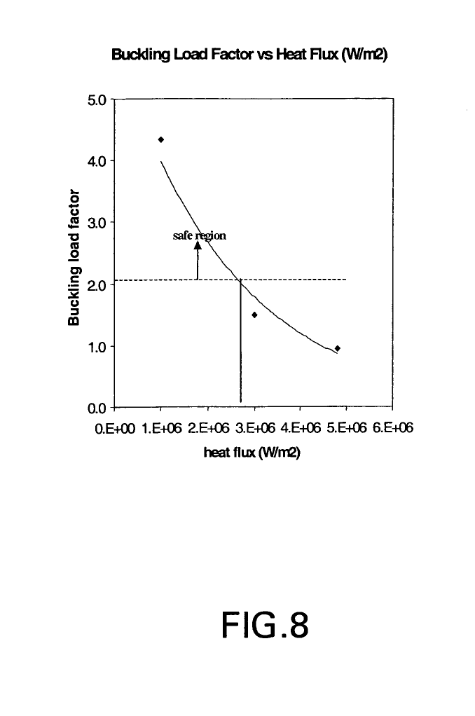

In deposited fuel cell environments, the surface of the substrate can get extremely hot due to molten particulates, especially in process such as air plasma, vacuum plasma, chemical vapor deposition or other deposition techniques. Due to reduced thermal conductivity in the substrate and the thickness of the substrate over certain unsupported regions, the thermal gradient can drive buckling failure. FIG. 8 graphically represents the relationship that will set the heating limits mechanically allowable for deposition process for this particular embodiment. These relations determine the basic design parameters of substrate design based on mechanical failure.

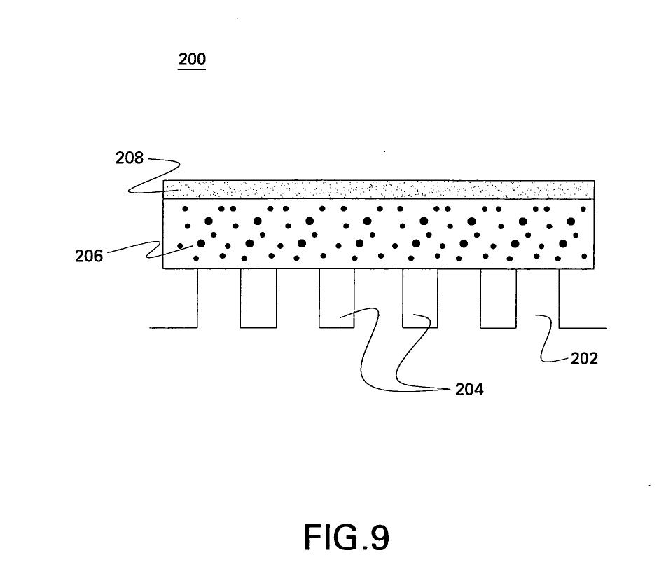

An electrochemical cell structure 200 comprising a conductive base 202 defining a plurality of holes 204 passing through the conductive base 202, a coarse microporous cellular substrate 206 disposed on the conductive base and a fine microporous cellular substrate 208 disposed on the coarse microporous cellular substrate 206, is shown in FIG. 9. This embodiment discusses a bi-functional microporous cellular substrate. The coarse microporous cellular substrate 206 consists of a large pore foam or other material that promotes gas diffusion and improved overall gas flow, as well as overall improved structural integrity, covered by a fine pore microporous cellular substrate 208 that promotes improved electrochemical reactivity. This bi-functional microporous cellular substrate provides better structural integrity as a support for the deposition of the other fuel cell components and will resist buckling and large compressive load failure during the assembly process. While this embodiment discusses two substrates of varying pore size, this invention may include more than two substrates and may have more than two different average pore sizes. In fact, this invention contemplates that the bi-functional microporous embodiment could be a single layer having a continuous gradient from large pore size at the conductive base to a fine pore size adjacent the electrolyte.

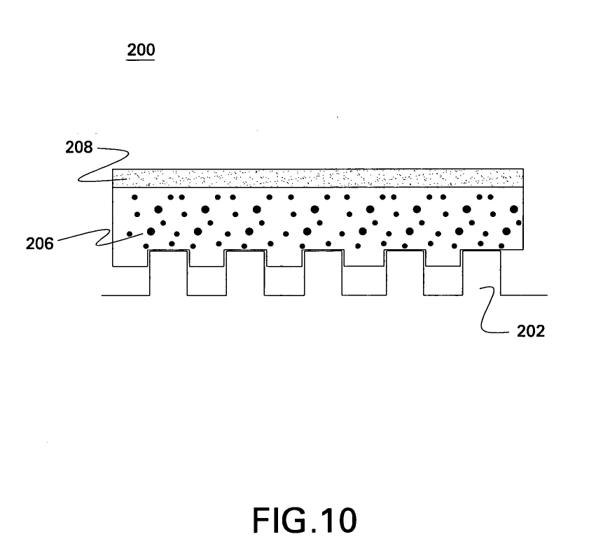

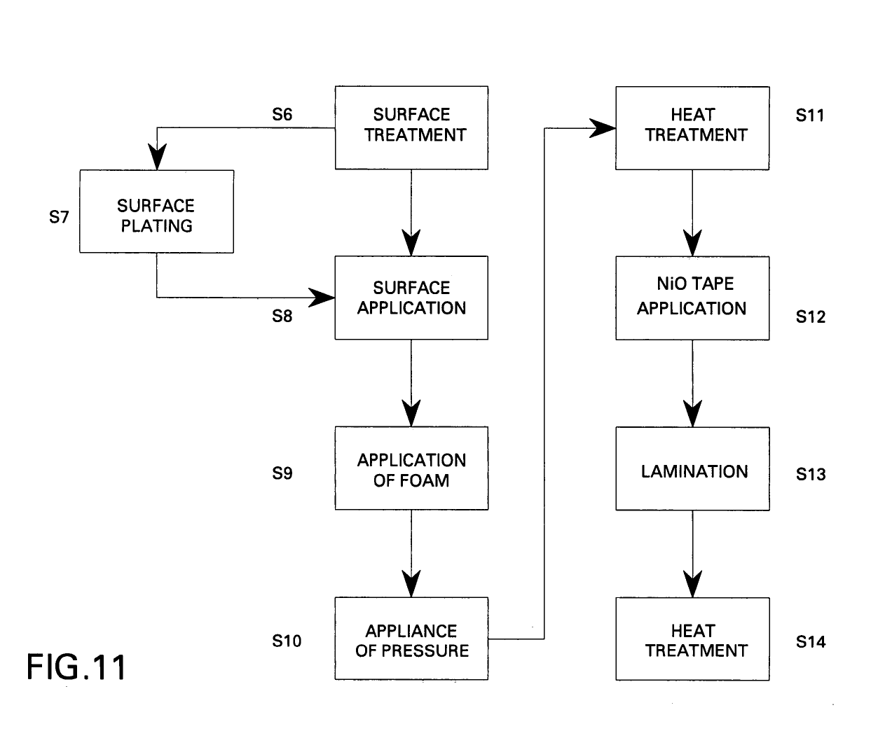

In an alternative embodiment, the coarse microporous cellular substrate 206 at least partially interpenetrates into conductive base 202, as shown in FIG. 10. One method of making this embodiment is depicted in the method steps of FIG. 11. First, in method step S6 the surface of the conductive base 202, typically a metallic interconnect, is cleaned. The surface can be cleaned using a chemical process or a mechanical process such as grit blasting. Next, in optional step S7, the surface of the conductive base 202 is coated with Ni-plating to enhance the bonding with the microporous cellular substrate. Additionally, Ni-plating also provides a protective layer against oxidation of the conductive base 202 during the subsequent heat treatments or during reduction of NiO.

Next, in step S8, a chemical glue, typically in the form of a Ni-metalorganic compound is applied over the conductive base 202 surface. The metalorganic compound is selected from Ni-acetyl acetonate, Ni-octoate, Ni-decanoate, or from a number of Ni-alkoxides. Alternatively, Ni or NiO paste, which is prepared by mixing Ni or NiO powder with organic solvents and binders, can be used as a gluing layer.

Next, in step S9, a porous open cell structure or foam with a typical relative density of about 0.6 to about 0.9 and a pore size of between about 150 to about 300 microns is placed on top of the conductive base 202.

Next, in step S10, suitable pressure is then applied to the structure and the foam is partially compressed into the holes 204 of the conductive base 202, thereby increasing the relative density of the supported regions. The pressure can be applied using a press or any load giving apparatus, typically having the structures positioned between two smooth high stiffness plates. A smooth outer surface is obtained after this process.

Next, in step S11, the assembly is heated in a reducing atmosphere to a temperature in the range between about 900 C to about 1050 C, to create a diffusion bond between the foam and the conductive base 202.

Next, in step S12, green NiO tape is placed upon the assembly as the next layer and a low stiffness roller is used across the entire surface to create an initial bond. Typically, prior to attaching the NiO tape, the surface of the macroporous foam is painted with Ni-metalorganic solution that initially acts as a glue that holds the tape and substrate together. The metalorganic layer also enhances bonding between the macroporous foam and porous Ni layer that results from the reduction of the NiO tape by leaving behind a thin Ni layer that results from the reduction of the NiO tape by leaving behind a thin layer of metal upon subsequent heat treatment. The metalorganic compound is selected from Ni-acetyl acetonate, Ni-octoate, Ni-decanoate, or from a number of Ni-alkoxides. Alternatively, NiO can be applied to the assembly by screen-printing a NiO paste. This may require the application of several layers until the desired thickness is built up.

Next, in step S13, the assembly is placed into a vacuum bag and heated to between about 150 C to about 200 C to laminate the NiO tape to the assembly. This step is not necessary if the NiO paste is used.

Finally, in step S14, the complete adhesion of the tape or paste layer to the assembly is accomplished by the final heat treatment, which heat treatment typically consists of binder burnout and reduction/sintering segments. Binder burnout from the green NiO layer is achieved by heating in air to between about 350 C to about 400 C. This is followed by heating in a reducing atmosphere in the range between about 800 C to about 1000 C to reduce NiO to Ni and sinter the Ni into a porous layer.

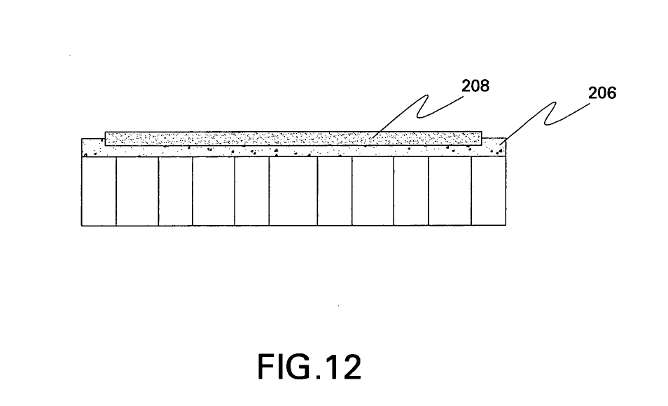

In another embodiment, the fine microporous cellular substrate 208 at least partially interpenetrates into the coarse microporous cellular substrate 206, as shown in FIG. 12.

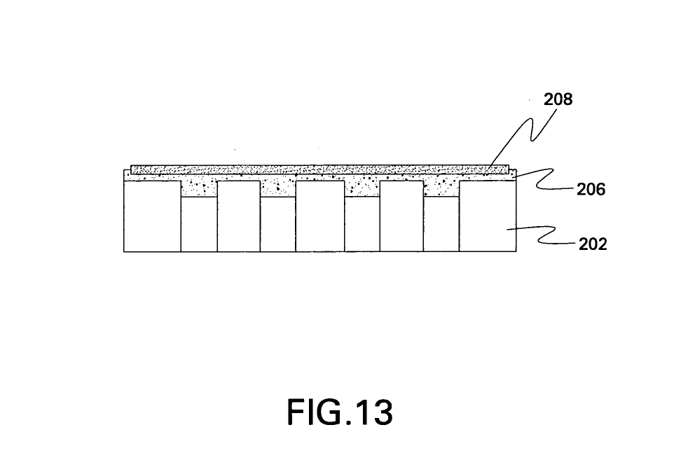

In yet another embodiment, the coarse microporous cellular substrate 206 at least partially interpenetrates into conductive base 202 and the fine microporous cellular substrate 208 at least partially interpenetrates into the coarse microporous cellular substrate 206, as shown in FIG. 13.

As discussed herein, the electrolyte materials may comprise any conventional electrolyte material including, for example: yttria-stabilized zirconia; lanthanum gallate; doped cerium oxide; ceria-stabilized zirconia; a stabilized zirconia like CaO-stabilized zirconia, MgO-stabilized zirconia, M₂O₃ stabilized zirconia, where M is taken from the group of Y, Sc, Yb, Nd, Sm, or Gd; lanthanum gallate having a general composition of La_{1-x-w}Sr_{x-w}Ga_{1-y}Mg_{y+z}O_{3-0.5(x+y+5w-2z)} where, 0.3≧x≧0.1; 0.3≧y≧0.1; 0.04≧w≧0.01; 0.15≧z≧0.03; doped cerium oxide where CeO₂ is doped with one or a mixture from La₂O₃, Y₂O₃, Sm₂O₃, Gd₂O₃, other rare earth oxides, Gd₂O₃+Pr₂O₃, CaO, SrO; certain stabilized Bismuthsesquioxides, Bi₂O₃-MO, where M is calcium, strontium or barium; Pyrochlore oxides of the general formula A₂B₂O₇, particularly Ln₂Zr₂O₇, where Ln is a lanthanoid such as Gd₂(ZrₓTi₁₋ₓ)₂O₇ (GZT) and Y₂(ZrₓTi₁₋ₓ)₂O₇ (YZT); or Perovskite structures such as BaCe_{0.9}Gd_{0.1}O₃, CaAl_{0.7}Ti_{0.3}O₃, SrZr_{0.9}Sc_{0.1}O₃; or combinations thereof.

As discussed herein, the electrode materials may comprise anode materials and cathode materials. The anode materials may comprise any conventional anode material including, for example: a mixture comprising an electronically conducting material such as at least one of a metal and a metal oxide that will be subsequently reduced to form the metal, and an ionically conducting material; at least one of nickel, nickel oxide, a platinum-group metal; a single phase of an electronically conducting materials; certain metals including Ni, Co, Pt, Pd or Ru; mixed oxide conductors including the ZrO₂—Y2O₃—TiO₂ system; or combinations thereof. The cathode materials may comprise any conventional cathode materials including, for example: a mixture comprising an electronically conducting material such as at least one of a metal and a metal oxide that will be subsequently reduced to form the metal and an ionically conducting material; at least one of nickel, nickel oxide or a platinum-group metal; lanthanum strontium manganite; doped lanthanum cobaltite; a mixture comprising at least one of a platinum-group metal, lanthanum strontium manganite, doped lanthanum ferrite, and doped lanthanum cobaltite and an electronically conducting material; doped lanthanum manganite; La MnO₃ substituted with various cations such as Ba, Ca, Cr, Co, Cu, Pb, Mg, Ni, K, Rb, Na, Sr, Ti, or Y; lanthanum strontium manganite having a general formula of La₁-xSrxMnO₃, which can also be further doped with Co or Cr; lanthanum cobaltite; LaCoO3 doped with Sr, Ca, Mn, or Ni to adjust conductivity or thermal expansion; doped lanthanum ferrite, for example La_{0.8}Sr_{0.2}FeₓCo_{y}O₃; or combinations thereof.

In addition, while the current invention is discussed in terms of two electrodes, a cathode and an anode, with an electrolyte disposed therebetween, other embodiment may include additional layers. For example, certain embodiments can include buffer layers deposited between the electrodes and the electrolyte. These buffer layers may be included for a variety of reasons including, without limitation, to prevent deleterious chemical interaction between the other layers. For example, some embodiments may include an interlayer of cerium-gadolinium oxide, or the like, that can be used to reduce the interdiffusion and chemical interaction between a layer of YSZ and a layer of lanthanum cobaltite, lanthanum strontium ferrite or mixtures thereof. Similarly, an interlayer of samarium-doped cerium oxide (Ce1-xSmxO2-0.5x) can be used to reduce the interdiffusion and chemical interaction between a composite anode of NiO: CeO₂ and LSGM (La_{1.8}Sr_{0.2}Ga_{1-y}Mg_{y}O_{2.9-0.5y}, where 0.05<y<0.3).

Several of the embodiments discussed within this specification provide a high porosity support or substrate for deposition, especially for large surface area deposition, with each support tailored for low gas transport resistance and robust to mechanical and thermal stresses. Additionally, several of the embodiments provide a relatively smooth outer surface that is suitable for a variety of deposition methods. The conductive base discussed in this invention is typically an interconnect, and more specifically, a metal interconnect. The porous or microporous support material or substrate material can comprise either the cathode material or the anode materials, or alternatively, the porous or microporous support material can comprise another layer such as a gas diffusion layer. In many of the embodiments, porous or microporous support material is the electrode and provides a relatively smooth surface for deposition of the remaining cell layers. Additionally, many of the embodiments involve the use of a mesh material, like screen, attached to the conductive base. Typically, this mesh material is made of the same or similar material of the conductive base. In the case where the conductive base and the mesh material are each made of an interconnect material, the resulting structures have improved mechanical durability, the current pathway is less sensitive to cracks that typically develop parallel to the electrode/interconnect surface since the current can travel laterally to the mesh material and then to the conductive base. Additionally, the dimensions of the unsupported electrode and electrolyte layers is greatly reduced to the smaller dimensions of the interstices of the mesh material, adding even more mechanical durability to the resultant cell.

While only certain features of the invention have been illustrated and described herein, many modifications and changes will occur to those skilled in the art. For example, while several of the embodiments of this invention have been discussed in terms of a fuel cell stack arrangement, this is not a limitation of the invention, in fact this invention is contemplated for use within other fuel cell arrangements including, for example, tubular fuel cell bundles or arrangements. It is, therefore, to be understood that the appended claims are intended to cover all such modifications and changes as fall within the true spirit of the invention.

1. An electrochemical cell support structure comprising:
a conductive base defining a plurality of holes passing through said conductive base; and
a microporous cellular substrate disposed on said conductive base.

2. An electrochemical cell support structure in accordance with claim 1, wherein said conductive base comprises a metallic interconnect made of at least one of iron, chromium, nickel, tin or combinations thereof.

3. An electrochemical cell support structure in accordance with claim 1, wherein said conductive base comprises a metallic interconnect made of ferritic stainless steel.

4. An electrochemical cell support structure in accordance with claim 1, wherein said plurality of holes have a dimension in the range between about 0.025 to about 13 millimeters.

5. An electrochemical cell support structure in accordance with claim 1, wherein said electrochemical cell is a solid oxide fuel cell.

6. An electrochemical cell support structure in accordance with claim 1, wherein said electrochemical cell is a solid oxide electrolysis cell.

7. An electrochemical cell support structure in accordance with claim 1, wherein at least one of an electrode or an electrolyte is deposited upon said a microporous cellular substrate.

8. An electrochemical cell support structure in accordance with claim 7, wherein said electrode or said electrolyte is deposited using at least one of atomistic deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF).

9. An electrochemical cell support structure in accordance with claim 1, wherein said conductive base comprises a metallic interconnect made of iron chromium, nickel chromium, nickel iron chromium, or combinations thereof.

10. An electrochemical cell support structure in accordance with claim 1, wherein said microporous cellular substrate comprises a porous nickel.

11. An electrochemical cell support structure in accordance with claim 1, wherein said microporous cellular substrate comprises a iron, chromium, nickel, tin or combinations thereof.

12. An electrochemical cell support structure in accordance with claim 1, wherein said microporous cellular substrate is an electrode.

13. An electrochemical cell support structure in accordance with claim 1, wherein said microporous cellular substrate is grown on said conductive base using at least one of a chemical or an environmental heat treatment.

14. An electrochemical cell support structure in accordance with claim 1, wherein said microporous cellular substrate is pre-manufactured and subsequently attached to said conductive base.

15. An electrochemical cell support structure in accordance with claim 1, wherein said microporous cellular substrate is made by sintering a metallic powder.

16. An electrochemical cell support structure in accordance with claim 1, wherein said microporous cellular substrate is made by filling in macroporous foam with a metallic paste and treated to generated an appropriate microporous structure.

17. An electrochemical cell support structure in accordance with claim 1, wherein said microporous cellular substrate is made by spray deposition or tape casting of metallic or metal-precursor particles.

18. An electrochemical cell support structure in accordance with claim 1, wherein said microporous cellular substrate has an average pore size in the range between about 5 to about 30 microns.

19. An electrochemical cell support structure in accordance with claim 1, wherein said microporous cellular substrate has an average pore size in the range between about 10 to about 20 microns.

20. An electrochemical cell support structure in accordance with claim 1, wherein said microporous cellular substrate has an average porosity in the range between about 40 percent to about 85 percent.

21. An electrochemical cell support structure in accordance with claim 1, wherein said microporous cellular substrate has an average porosity in the range between about 50 percent to about 75 percent.

22. An electrochemical cell support structure comprising:
a conductive base defining a plurality of holes passing through said conductive base;
a coarse microporous cellular substrate disposed on said conductive base; and
a fine microporous cellular substrate disposed on said coarse microporous cellular substrate.

23. An electrochemical cell support structure in accordance with claim 22, wherein said coarse microporous cellular substrate supports gas diffusion.

24. An electrochemical cell support structure in accordance with claim 22, wherein said fine microporous cellular substrate supports electrochemical reactivity.

25. An electrochemical cell support structure comprising:
a conductive base defining a plurality of holes passing through said conductive base;
a coarse miroporous cellular substrate disposed on and at least partially interpenetrating into said conductive base;
a fine microporous cellular substrate disposed on said coarse microporous cellular substrate.

26. An electrochemical cell support structure comprising:
a conductive base defining a plurality of holes passing through said conductive base;
a coarse microporous cellular substrate disposed on said conductive base;
a fine microporous cellular substrate disposed on and at least partially interpenetrating into said coarse microporous cellular substrate.

27. An electrochemical cell support structure comprising:
a conductive base defining a plurality of holes passing through said conductive base;
a microporous cellular substrate disposed on said conductive base; wherein said microporous cellular substrate has a gradient from large pore size adjacent said conductive base to a fine pore size adjacent a top surface of said microporous cellular substrate.

28. An electrochemical cell structure comprising:
a conductive base defining a plurality of holes passing through said conductive base;
a microporous cellular substrate disposed on said conductive base; and
at least one of an electrode or an electrolyte disposed upon said cellular substrate.

29. An electrochemical cell structure in accordance with claim 28, wherein said microporous cellular substrate is an electrode.

30. An electrochemical cell structure in accordance with claim 29, wherein said electrolyte sealingly overlaps said microporous cellular substrate.

31. A method of fabricating an electrochemical cell structure comprising the method steps of:
providing a conductive base that comprises a plurality of through holes;
attaching a microporous cellular substrate to said conductive base to provide a substantially smooth outer surface;
depositing at least one of an electrode material or an electrolyte material upon said substantially smooth outer surface.

32. A method in accordance with claim 31, wherein said step of depositing at least one of an electrode material or an electrolyte material uses at least one of atomistic deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF).
